(19) United States
(12) Patent Application Publication
(10) Pub. No.: US 2026/0047718 A1
(43) Pub. Date: Feb. 19, 2026

(54) COOKING APPARATUS

(71) Applicant: ILLINOIS TOOL WORKS INC., Glenview, IL (US)

(72) Inventor: Thomas AMSTUTZ, Sins (CH)

(21) Appl. No.: 19/297,288

(22) Filed: Aug. 12, 2025

(30) Foreign Application Priority Data
Aug. 14, 2024 (DE) 10 2024 123 262.5
Jul. 24, 2025 (EP) 25191557.5

(51) Int. Cl. A47J 36/06; A47J 36/32; E05F 1/12; G01D 5/16

(52) U.S. Cl. CPC A47J 36/06; A47J 36/32; E05F 1/1223; G01D 5/16

(57) ABSTRACT

A cooking apparatus includes a pot device having a housing, a lid device for closing the pot device, a hinge device having a hinge housing that pivotally connects the lid device to the top device, and a detection device for detecting an opening state of the lid device, wherein the detection device is arranged in the region of the hinge device.

### TECHNICAL FIELD

The invention relates to a cooking apparatus for preparing food.

### BACKGROUND

In large-scale kitchens, food is prepared primarily in high-capacity containers. Such containers are referred to as a pot or pan.

Depending on the type of cooking, a different form of cooking container is preferably used.

During frying, a cooking container is used that has a relatively flat shape in order to provide a relatively large opening in relation to the volume of the container body.

The larger opening compared to volume reduces liquid faster than in a cooking container of the same volume. Cooking containers of this form are defined as pans. The rapid reduction of liquid is particularly beneficial when frying, as the frying process is characterized by cooking with relatively high dry heat.

By contrast to the pan, a saucepan has a smaller opening relative to the volume of the cooking container. This maintains liquid in the saucepan for longer. That is why a saucepan is used when cooking in hot water of approximately 100° C.

In other types of cooking, such as stewing or steam cooking or an intermediate form, a lid is placed on the saucepan or pan in order to reduce the reduction of liquid despite heating. Thus, more liquid remains in the food.

In steam cooking, a cooking space is filled with steam and the food to be steamed is placed inside. To produce such a cooking space, water is brought to a boil in order to allow water vapor to spread over the surface of the boiling water. A lid is used in order to hold the water vapor in the cooking space.

Braising is a combined cooking process wherein the food is first fried and then further cooked in boiling liquid. To do this, the food is fried under dry heat without a lid and then mixed with a liquid held in the saucepan by a lid.

Depending on the type of food, different types of cooking are used for the preparation. The position or the opening state of the lid plays a role here.

The lids for containers in large kitchens are often difficult to place on the pots or pans by hand due to their size and weight. Therefore, the lids are usually pivotally attached to the edge of the opening of the containers.

To realize various opening states of the lid and/or to assist an operator in changing the opening state of the lid, special lid swivel joints have been developed.

Document DE 10 2017 210 842 B3 provides a lid swivel joint for a kitchen implement for changing the opening state of the lid. A central piece connected to the lid is affixed between two bearing blocks. A fixed cam element is connected to one of the bearing blocks. A second cam element is fixedly connected to the central piece. The two cam elements interlock such that the two cam paths are in sliding engagement and a maximum adjustment angle of the lid is defined by the stop of the cam elements.

Rotational joints for holding or adjusting the lid opening of cooking containers in large-scale kitchens are accordingly known.

Depending on the recipe, it is necessary to hold or change a specific lid opening of the cooking container. Because several of these cooking containers are often used in parallel in large-scale kitchens, it is necessary to keep track of the opening states of the lids. For example, some dishes may require the lid to be open for 2-3 minutes in order to sear and then braise or cook through for 1-2 hours.

### SUMMARY

The problem addressed by the invention is to provide an apparatus through which, on the one hand, the lid of a large-scale kitchen cooking container can be mounted in different states, and on the other hand, the lid opening over the cooking apparatus can be determined.

Furthermore, the invention addresses the problem of determining a reliable and low-maintenance lid opening.

A cooking apparatus according to the present invention comprises:
a pot device,
a lid device for closing the pot device,
a hinge device that pivotally connects the lid device to the pot device, and
a detection device for detecting an opening state of the lid device,
wherein the detection device is arranged in the region of the hinge device.

The pot device can either be formed as a pot or saucepan or pan.

The lid device for closing the pot device is configured such that the opening of the pot device can be fully or partially closed.

By way of the hinge device, the lid device is pivotally connected to the pot device. The lid device, which requires force exerted by the operator due to its size and its weight, therefore does not have to be placed manually on the pot device. This results in the advantage that no separate space for the lid device must be found in the opening state.

Furthermore, by the pivotable connection of the lid device to the pot device, a quick change of the opening state is possible. The lid device only has to be moved about a pivot axis. Due to the hinge device, a simple opening and/or folding of the lid device is thus possible.

In addition, the hinge device ensures that the lid device is correctly placed on the pot device in the closed state. Thus, in the closed position, a suitable sealed position of the lid device can be ensured on the pot device.

The detection device for monitoring the opening state of the lid device is particularly advantageous when several cooking apparatuses are present in a large-scale kitchen. Thus, it can be monitored which devices have which opening state of the lid device.

The advantage of the arrangement of the detection device in the region of the hinge device is that the movements are readable directly in the hinge device.

The hinge device can comprise a housing, wherein the detection device is arranged within the housing of the hinge device. In particular, the detection device is protected from external influences via the housing of the hinge device.

By contrast to a detection device attached to the edge of the pot device or the lid device as a pin element or opto-electronic sensor, such an arrangement (i.e., within the hinge housing) results in the detection device being protected from external influences. Thus, when cooking or cleaning the cooking apparatus, the detection device does not come into contact with food residues or cleaning agents. This increases the service life and reliability of the detection device.

For example, it is possible for a rotational potentiometer to be arranged in the hinge device and to accommodate the rotational movement of the hinge device or for the movement of the hinge device to be transmitted to a sensor inside the housing.

The detection device can comprise an encoder element for the translation of a pivoting movement (rotation of the lid) into a linear movement and a sensor for recording the linear movement.

The translation of a pivoting movement into a linear movement proves to be particularly advantageous, because no angular magnitude must be determined; rather, a linear change in the path reflects the (opening) position of the lid device.

The encoder element can be arranged in the hinge device (within the hinge housing) and can project into the housing of the pot device or an adjacent housing of the detection device. The encoder element can be configured so as to cooperate with the sensor, and the sensor can be arranged in a sealed manner in the housing of the pot device or in the adjacent housing of the detection device.

This results in the advantage that the sensor is protected from external influences by the housing of the hinge device and/or the detection device. This increases the longevity and reliability of the sensor.

With this arrangement, the encoder element and the sensor are only connected by physical, mechanical contact. There is therefore no electrical contact between the hinge device and the sensor. In this way, the hinge device and sensor are independently interchangeable, further increasing the serviceability of the cooking apparatus.

Due to this arrangement, it is also possible to heat-seal the sensor. Furthermore, by means of a corresponding seal, no moisture reaches the electronics of the sensor (i.e., the hinge housing and the housing of the pot device or an adjacent housing of the detection device protect the hinge mechanism, the encoder element, and the sensor against external influences).

The hinge device can comprise a biasing element having a biased spring device, a fixed portion, and a moving portion. The circular surfaces or also cam surfaces of the moving part and the fixed part can interlock or be moved apart by a rotational movement of the hinge device. The spring device can thus be biased and/or relaxed accordingly.

In this way, the hinge device is able to maintain the lid device in a desired opening state solely by means of an appropriately adjusted spring force.

Different opening angles can be realized by the construction with the moving and fixed part and the associated cam surfaces (or so-called circular surfaces) which are coupled in an interlocking and contacting manner. That is to say, depending on the required lid opening, the lid device can be adjusted to a desired opening angle.

Furthermore, a spring force adjustment device can be provided. This comprises a plate-shaped element, which may be arranged on the side of the spring device opposite the biasing element between the spring device and the hinge casing and is slidable in the longitudinal direction of the spring device by means of an adjustment screw.

The lid weight (torque) can thus be precisely adjusted for the swivel joint, wherein the plate-shaped element is axially displaced by means of the adjustment screw until the spring force is adapted to the torque caused by the lid weight. The spring force and consequently the torque of the rotating device can thus be continuously adjusted. This is advantageous because differently sized and differently weighted lids can be provided. The adjustment region of the hinge device can be adjusted over a large torque region, e.g., by way of the number of springs (e.g., 3 pieces) included in the spring element and the adjustment screw that adjusts the spring tension.

The encoder element can be fixedly connected to the moving part of the spring device in order to implement a pivoting movement of the lid device correspondingly in a linear displacement of the moving part and thereby in a linear displacement of the encoder element in the axial direction.

By translating the pivoting movement into a linear displacement of the moving part, a linear movement of the encoder element can be detected.

The detection of a linear path offers the advantage over the detection of a pivoting or rotational movement, e.g., with a rotational potentiometer, that the wear caused by the service life in a rotational potentiometer has no significant impact on the measured variable.

The encoder element can deflect a probe by the displacement in the axial direction, so that the deflection of the probe can be detected by a linear sensor.

In this way, there is only a mechanical contact between the encoder element, which is fixedly connected to the hinge device within the hinge housing, and the sensor (e.g., within the housing of the pot device or in an adjacent housing of the detection device). This increases the ease of maintenance of the arrangement, because the hinge device and the sensor are independently interchangeable. Furthermore, no electrical interference (or an electrical charge) of elements of the hinge device can be transmitted to the sensor, which could erroneously influence the detection.

The linear sensor can comprise, e.g., a potentiometer, an ammeter, and/or an electrical switch for detecting a voltage change and/or current change at an evaluation device.

In particular, an electrical switch proves to be advantageous with a given arrangement, because the probe can be used as a shifter at the same time. In one embodiment, the shifter can be configured as a roller lever. This results in a more uniform force distribution, and the service life of the shift lever as well as the entire electrical switch is increased.

However, it is also possible for a potentiometer and/or an ammeter to be connected to the probe and for the voltage or current on the sensor to be changeable by a corresponding deflection of the probe.

The opening state can be a closed or an opened state of the lid device and/or the opening state can be determined by the detection device as any desired opening region or opening angle of the lid device.

With the present cooking apparatus, it is thus possible to determine whether the lid device is sitting on the pot device in an open or closed state. Furthermore, it can be determined whether the opening state is detectable as an opening region or opening angle of the lid device with respect to the pot device, i.e., to what extent the lid obscures the pot opening or what the opening angle of the lid is relative to the surface of the pot edge.

A desired opening region can be determined by, for example, the lid device being opened one quarter, one half, three quarters, or fully to the pot device, wherein the differences between quarter, half, three quarter, and fully are adjusted as step ranges. For example, it is also possible to define an opening region for the “braising” mode and a different opening region for the “cooking” mode. Reaching this opening region can be indicated by a display device.

The opening angle of the lid device compared to the pot device is determined in degrees. For example, an opening angle of 10° to 110° is conceivable. Depending on the hinge device, however, it is also possible to define an opening angle of 5°-90° or 10°-95°. The opening angle can be changed either incrementally, i.e., in 5° or 10° or 20° steps, or continuously. It is contemplated that the opening angle will be displayed as a degree number from a display device in the region of the cooking apparatus.

The opening state of the lid device can be adjustable by an actuator device.

The actuator device can be arranged either in the region of the hinge device or the lid device. As a result, it is possible for the actuator device to act on the hinge and/or lid device.

The evaluation device can be connected to a control device in order to control the opening state via the actuator device and/or a water supply and/or heating temperature via a feedback loop such that the preparation process is controllable within the cooking apparatus.

In this way, recipes that require different types of cooking in a particular order can be converted into an automatic program. The preparation of food can thus be automated, making it easier for operators to work in a wide-scale kitchen.

### BRIEF DESCRIPTION OF THE DRAWINGS

The present invention will be described in more detail in the following on the basis of an exemplary embodiment shown in the figures. The figures show:

FIG. 1 is a schematic, perspective view of a cooking apparatus according to the invention;

FIG. 2 is a perspective view of a hinge device according to the invention and a detection device mounted in the region of the hinge device within the hinge housing and/or the housing of the pot device;

FIG. 3 is an exploded view of an embodiment of the hinge device of the present invention;

FIG. 4A is a perspective view of the hinge device with a transparently illustrated hinge housing;

FIG. 4B is a bottom view of the hinge device;

FIG. 4C is a cutaway view along plane A-A;

FIG. 5 is a perspective, cross-sectional view along a longitudinal side of an embodiment of the hinge device and detection device according to the invention;

FIG. 6 is a perspective view of a hinge device having an embodiment of the cam surfaces of the cam elements, with the biasing element and spring device in the stressed state, and

FIG. 7 is a perspective view of a hinge device having an alternative embodiment of the cam surfaces of the cam elements, with the biasing element and spring device in the stressed state.

### DETAILED DESCRIPTION

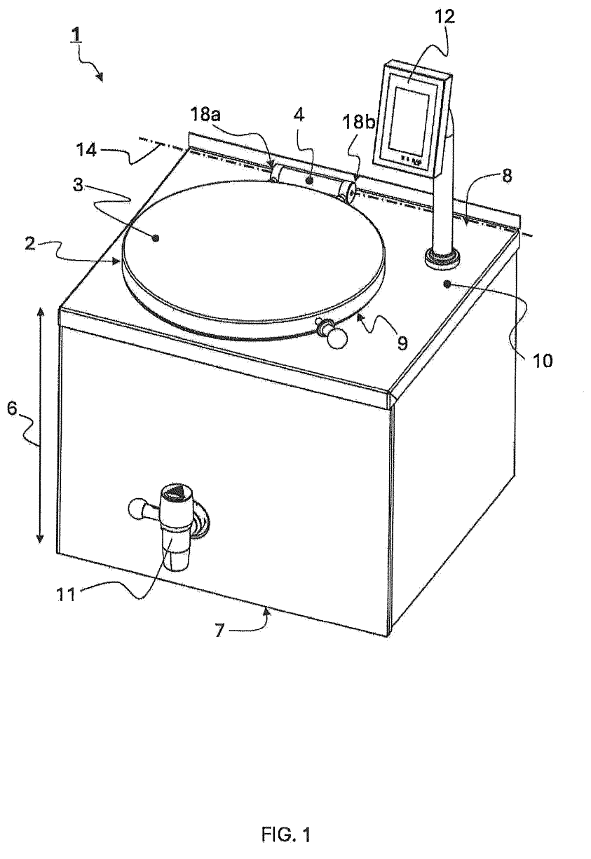

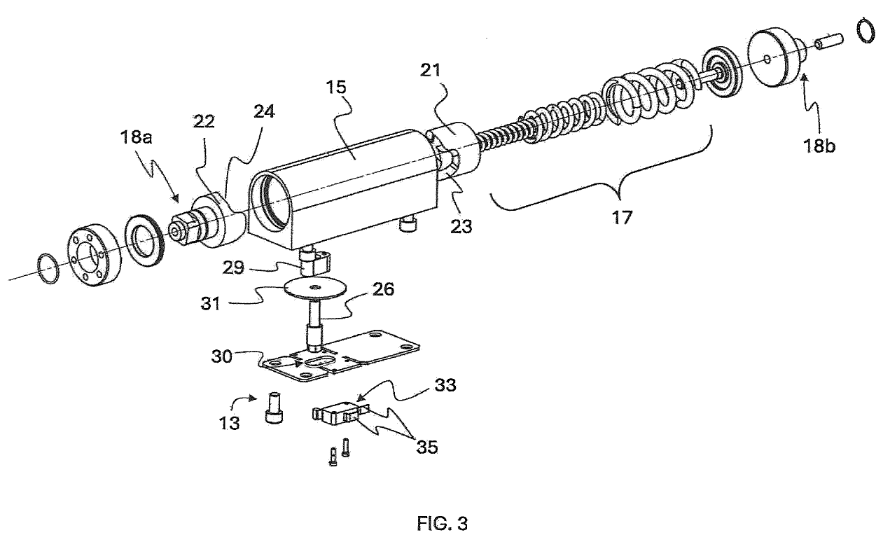

According to the present invention, there is provided a cooking apparatus 1 for preparing food in large-scale kitchens, which is described in view of FIGS. 1 to 7.

According to the present exemplary embodiment, the cooking apparatus 1 comprises a pot device 2, a lid device 3, a hinge device 4, and a detection device 5.

The pot device 2 is a pan or a saucepan. Compared to the saucepan, the pan has a larger opening relative to volume. The pot device 2 can have both an approximately circular and an approximately rectangular cross-section. A volume from a lower side 7 to an upper side 8 is subtended from the pot device 2 in the axial direction 6. A pot opening 9 is arranged on the upper side 8 of the pot device 2. The pot device 2 is enclosed in a housing 10, which exceeds the volume of the pot device 2. The housing 10 as well as the pot device 2 are formed from an easily cleanable material, for example stainless steel or brass or ceramic (FIG. 1).

According to the present exemplary embodiment, a water terminal 11 and a display device 12 are mounted on the housing 10. Within the housing 10, there are heating elements that serve to heat up the pot device 2 (FIG. 1).

The hinge device 4 is also arranged in the region of the upper side 8 of the housing 10.

The hinge device 4 is configured so as to connect the housing 10 or frame and the lid device 3. The lid device 3 is moved relative to the housing 10 via the hinge device 4. The pot device 2 is thereby opened or closed with the lid device 3. The hinge device 4 thus performs a rotational movement, which results in an on/off movement or a pivoting movement of the lid device 3.

The housing 10 and the hinge device 4 are screwed together by means of a screw connection at screw points 13 in the region of the hinge device 4, which faces in the direction of the housing 10.

The lid device 3 is attached along a longitudinal axis 14 at two opposite ends of the hinge device 4. The longitudinal axis 14 runs parallel to the upper side of the pot device 2.

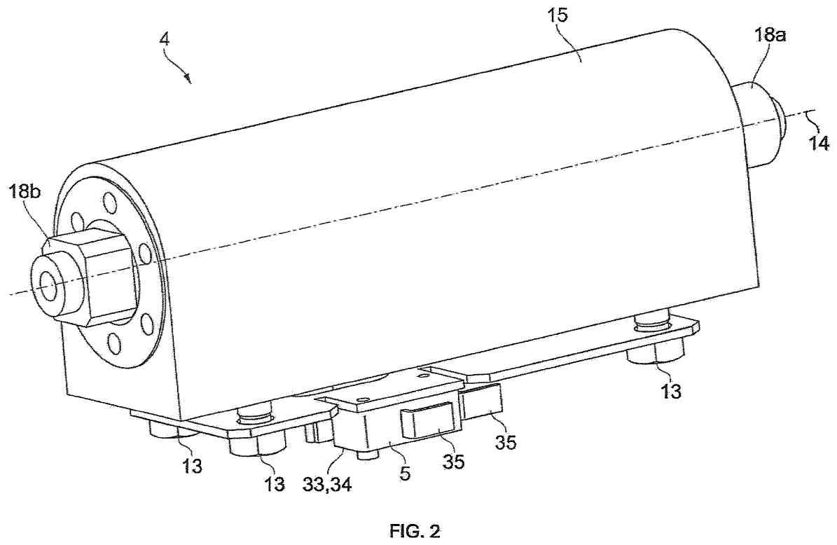

FIGS. 2, 3, and 4A show that the hinge device 4 is surrounded by a hinge casing 15. In this way, a biasing element 16 and a spring device 17, as well as the detection device 5, are protected from external influences by the hinge casing 15.

The lid device 3 and the hinge device 4 are connected to one another by a screw connection at the fastening points 18 (i.e., 18a and 18b). Furthermore, the lid device 3 and the hinge device 4 are connected to the housing 10 at the fastening points (e.g., via bolt points 13).

In order for the lid device 3 to be retained in an opening state by the hinge device 4, the biasing element 16 must apply a holding force. The holding force is generated by the spring device 17 with the biasing element 16. For this purpose, the hinge device 4 comprises a moving part 19 and a fixed part 20. The mechanism described below is already known from document DE 10 2017 210 842 B3.

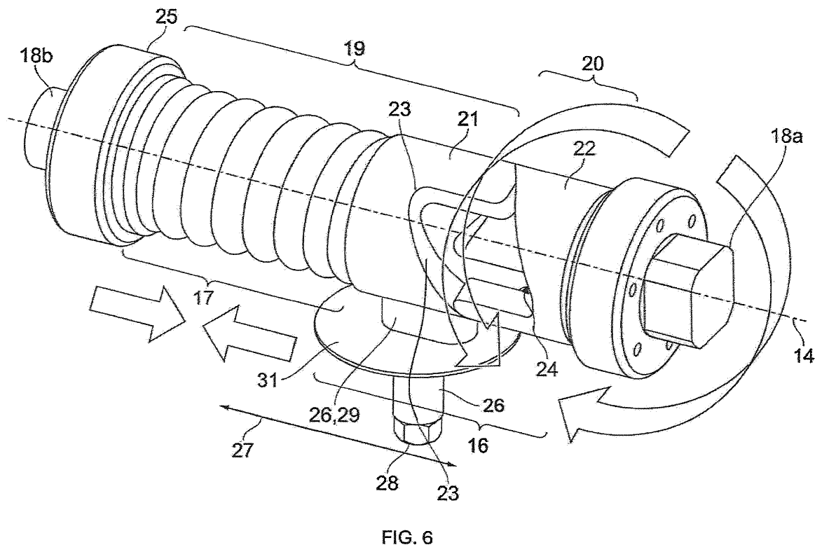

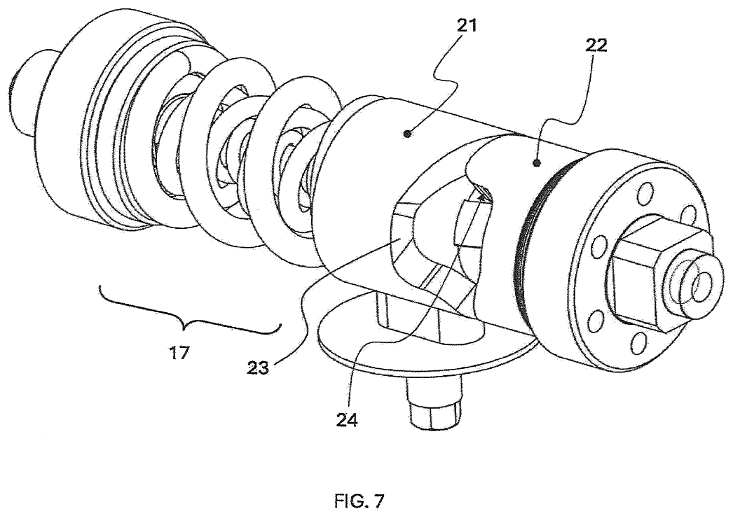

The two parts 19, 20 each comprise cam elements 21, 22 which face one another and are correspondingly shaped so that they can interlock or can be moved apart via circumferential cam surfaces 23, 24 (such as cam surfaces that correspondingly slide towards one another). The first cam element 21 on the moving part 19 comprises a first cam, or so-called circumferential, circular surface 23. Correspondingly, the second cam element 22 of the fixed part 20 comprises a second cam, or so-called circumferential, circular surface 24. The cam or circular surfaces 23 and 24 feature a sliding engagement. Furthermore, a stop is formed on the cam elements 21 and 22, whereby the rotational movement of the cam elements 21 and 22 relative to one another is limited. The biasing element 16 comprises the operatively coupled cam elements 21 and 22. FIGS. 6 and 7 show various embodiments of the cam elements 21 and 22 with correspondingly different cam surfaces 23 and 24.

An on/off movement thus corresponds to the pivoting movement of the lid device 3. In a rotational movement of the fixed part 20, the linear on/off movement of the lid device 3 is implemented at the fastening point 18a. The movement of the fixed part 20 is transferrable from the second cam element 22 to the first cam element 21. In an upward movement of the lid device 3, the second cam element 22 pushes the first cam element 21 away from itself in the region of the respective circular surfaces 24 and 23, so that the force of the rotational movement compresses the spring device 17 counter to the spring force of the at least one spiral spring 25.

The spiral spring 25 comprises at least one or more springs or spiral springs (e.g., three springs coupled in parallel) that interlock or are arranged inside one another. The spiral spring 25 is arranged between the second fastening point 18b and the first cam element 21 along the longitudinal axis 14.

The upward motion causes the force required for this purpose to be converted into an axially directed linear motion by means of the cam elements 21 and 22, so that this force can be stored in the compressed spiral spring 25. The spiral spring 25 is then held in the compressed position by the cam surfaces 23 and 24 standing opposite one another in a sufficient frictional lock.

In a downward motion, the cam surfaces 23, 24 of the cam elements 21 and 22 slide one over the other so that the spiral spring 25 can relax in the axial direction.

In addition, an adjustment device can be arranged in the hinge casing 15 in order to determine the angle of rotation between the lid device and the housing.

Furthermore, a spring force adjustment device (not shown) can be provided. This comprises, for example, a plate-shaped element, which is arranged on the side of spring device 17 opposite the biasing element 16 between the spring device 17 and the hinge casing 15 and is slidable in the longitudinal direction of the spring device 17 by means of an adjustment screw (not shown).

By means of the spring force adjustment device, the biasing of the spring device 17 can be continuously adjusted so as to be able to adapt it accordingly to different lids.

Upon a pivoting movement of the lid device 3, an encoder element 26 of the detection device 5 functions to convert the resulting torque and the linear displacement of the spring device 17 carried out by the cam surfaces 23, 24 into a detectable displacement. Parallel to the displacement of the moving part 19, the encoder element 26 thus moves in a linear measuring region 27 that extends parallel to the longitudinal axis 14. For this purpose, the encoder element 26 is fixedly connected to the first cam element 21. The encoder element 26 is arranged parallel to the axial direction 6 in the direction of the lower side 7 of the housing 10 (see FIGS. 2, 3, and 4).

For a fixed connection to the cam element 21, the encoder element 26 comprises a screw connection 28. The encoder element 26 comprises a first spacer element 29 and a second spacer element 30, between which a separation element 31 is arranged. The separation element 31 extends in an approximately circularly radial manner to the screw connection 28 parallel to the longitudinal axis 14 [and] forms a barrier between the hinge device 4 and the housing 10 so that no food residues, cleaning agents, liquids, etc. can penetrate into the housing 10.

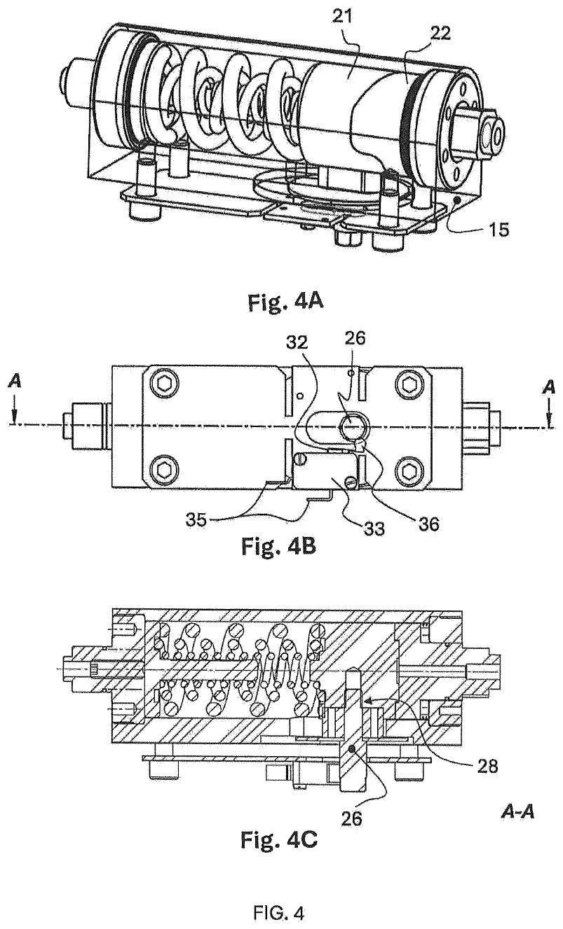

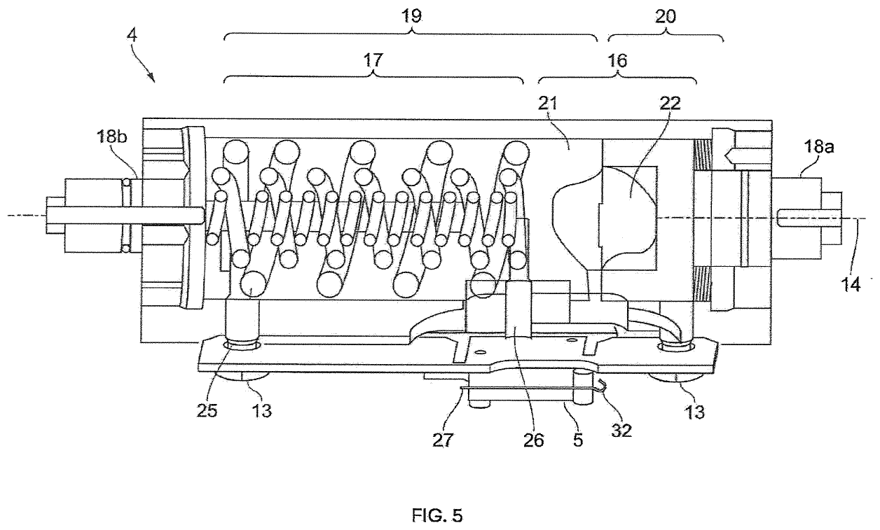

The encoder element 26 deflects a probe 32 by the displacement of the moving part 19, such that the deflection of the probe 32 is detectable by a linear sensor 33 in the measurement region 27. The probe 32 is formed from a pliable material, such as a thin metal plate, so as to be able to track the movement of the encoder element 26. The probe 32 extends along the path of movement of the encoder element 26 parallel to the longitudinal axis 14 (see FIG. 4B and FIG. 5). The encoder element 26 slides along the probe 32. In order for the probe 32 to always be in contact with the encoder element 26, a reinforcement in the form of an approximately cylindrical body 36 is attached at one end of the probe 32 for the event of the largest possible deflection, i.e., when the spring device 17 is relaxed and the encoder element 26 takes the next position towards the fixed part 20.

The other end of the probe 32 is introduced into the housing 34 of the linear sensor 33.

The linear sensor 33 can detect a voltage change and/or current change at an evaluation device. The linear sensor 33 is configured as a potentiometer, ammeter, and/or electrical switch for this purpose.

In the present exemplary embodiment, the linear sensor 33 is configured as an electrical switch, in particular as a microswitch. A probe is integrated into the microswitch as a roller lever 32. The microswitch comprises two electrical contacts 35, via which the switching state is readable.

The roller lever 32 can already be deflected by a minor change in position of the encoder element 26. From a certain position of the encoder element 26, a switch-on point is reached during the pivoting movement, thereby interrupting or allowing a flow of current. Conversely, in the case of the pivoting movement, there is a switch-off point at another position of the encoder element 26 so as to prevent the switch from fluttering.

With a simple microswitch 33, the opening state can be a closed or opened state of the lid device 3. For example, a deflection over the switch-on point is to be assessed as a closed state of the lid device 3 and a deflection over the switch-off point is to be assessed as an open state. In the intermediate region, between the switch-on point and the switch-off point, no further opening state can be determined in this embodiment.

However, with the present invention, it is also possible that the opening state, any opening region, or an opening angle of the lid device 3 can be determined by the detection device 5. For this purpose, the linear sensor 33 must be able to detect, for example, several stages of current changes and/or voltage changes or even continuously variable changes. For example, an analog potentiometer would be conceivable for continuously variable detection. In the case of step detection, a digital circuit with an analog-digital converter could be employed.

The voltage change and/or current change is then determinable by an evaluation device. The evaluation device translates the determined current or voltage value into an opening state defined for this purpose. The evaluation device is connected to a display device 12, which shows the opening state. Optionally, the evaluation device or another control device is suitable for detecting the period of time, i.e., for how long the current opening state has already lasted, or for determining when it is to be changed. The display device 12 can also include a signal device that can generate visual or auditory stimuli. For example, an LED lamp can begin to flash or a speaker can sound a sound when the opening state is to be changed.

The evaluation device can furthermore be connected to an actuator device. The opening state of the lid device 3 can be changed by the actuator device. For example, the actuator device can be formed from a rod-shaped element and a motor. One end of the rod-shaped element is fixedly connected, e.g., to the edge of the lid device 3. The motor can then change the position of the rod-shaped element along its longitudinal axis so that a desired opening state of the lid device 3 can be adjusted.

Optionally, the evaluation device and actuator device are also connected to a control unit, which cooperates with the evaluation unit, the water supply, the heating elements, and other sensors, such as a temperature sensor and moisture sensor. The active control of the heating elements, the lid opening, and the water supply make an optimum cooking process achievable.

### LIST OF REFERENCE NUMERALS

1 Cooking apparatus
2 Pot device
3 Lid device
4 Hinge device
5 Detection device
6 Axial direction
7 Lower side
8 Upper side
9 Pot opening
10 Housing of pot device
11 Water terminal
12 Display device
13 Bolt points
14 Longitudinal axis
15 Hinge casing, housing
16 Biasing element
17 Spring device
18 Fastening points
19 Moving part
20 Fixed part
21 First cam element
22 Second cam element
23 First cam or circular surface
24 Second cam or circular surface
25 Spiral spring
26 Encoder element
27 Axial direction/closing direction
28 Screw connection
29 First spacer element
30 Second spacer element
31 Separation element
32 Probe
33 Linear sensor
34 Sensor housing (linear sensor)
35 Electrical contacts
36 Probe cylinder

1. A cooking apparatus comprising:
a pot device having a housing,
a lid device for closing the pot device,
a hinge device having a hinge housing that pivotally connects the lid device to the pot device, and
a detection device for detecting an opening state of the lid device,
wherein the detection device is arranged in the region of the hinge device.

2. The cooking apparatus according to claim 1, wherein the detection device is arranged within the hinge housing.

3. The cooking apparatus according to claim 1, wherein the detection device is arranged within the housing.

4. The cooking apparatus according to claim 1, wherein the detection device comprises an encoder element for the translation of a pivoting movement into a linear movement and a sensor for recording the linear movement.

5. The cooking apparatus according to claim 4, wherein the encoder element is arranged in the hinge device and projects into the housing of the pot device, wherein the encoder element is configured so as to cooperate with the sensor, and wherein the sensor is arranged in a sealed manner in the housing of the pot device.

6. The cooking apparatus according to claim 2,
wherein the hinge device comprises a biasing element having a biased spring device, a fixed part, and a moving part, wherein cam surfaces of the moving part and cam surfaces of the fixed part are coupled in an interlocking manner or decoupled while moving apart from one another by way of rotational movement of the hinge device, whereby the spring device can be correspondingly biased and/or relaxed.

7. The cooking apparatus according to claim 6, wherein the encoder element is fixedly connected to the moving part of the spring device such that, upon a pivotal movement of the lid device, it correspondingly translates the torque into a displacement of the moving part, and thereby of the encoder element, in the axial direction.

8. The cooking apparatus according to claim 7, wherein the encoder element deflects a probe by the displacement in the axial direction, so that the deflection of the probe can be detected by a linear sensor.

9. The cooking apparatus according to claim 8, wherein the linear sensor comprises a potentiometer, an ammeter, and/or an electrical switch for detecting a voltage change and/or current change at an evaluation device.

10. The cooking apparatus according to claim 1, wherein the opening state is a closed or opened state of the lid device, and/or that the opening state is any desired opening region or any desired opening angle of the lid device that can be determined by the detection device.

11. The cooking apparatus according to claim 1, wherein the opening state of the lid device can be adjusted by an actuator device, and/or that a spring force adjustment device is provided, [sic] which a plate-shaped element, which can be arranged on the side of the spring device opposite the biasing element between the spring device and the hinge cover and can be displaced in the longitudinal direction of the spring device by means of an adjustment screw in order to adjust the bias of the spring device.
